(19) United States
(12) Patent Application Publication
(10) Pub. No.: US 2021/0230726 A1
(43) Pub. Date: Jul. 29, 2021

(54) METHOD FOR PROCESSING A RAW WORKPIECE INTO A FINAL WORKPIECE

(71) Applicant: The Boeing Company, Chicago, IL (US)

(72) Inventors: Bart Stevens, North Charleston, SC (US); Bruce M. Griffin, St. Louis, MO (US); Michael Howard-Edward Ware, Renton, WA (US); Richard G. Wire, Auburn, WA (US); Paul N. Wilson, St. Charles, MO (US); Benjamin S. Stephenson, Auburn, WA (US)

(73) Assignee: The Boeing Company, Chicago, IL (US)

(21) Appl. No.: 16/751,868

(22) Filed: Jan. 24, 2020

(51) Int. Cl. C22F 1/043; B33Y 70/00; B33Y 80/00; B05D 1/18; C23F 1/20; B05D 7/14

(52) U.S. Cl. CPC C22F 1/043; B33Y 70/00; B05D 7/14; B05D 1/18; C23F 1/20; B33Y 80/00

(57) ABSTRACT

A method for processing a raw workpiece into a final workpiece is described, wherein the raw workpiece includes a metallic structure including silicon particles dispersed therein. The raw workpiece is fabricated employing an additive manufacturing process, in one embodiment. The method includes heat-treating the raw workpiece to produce an intermediate workpiece, wherein the heat-treating includes subjecting the raw workpiece to a first temperature environment for a time period to produce an intermediate workpiece to form agglomerated silicon particles, wherein the agglomerated silicon particles are disposed on a surface of the raw workpiece. The method further includes removing the agglomerated silicon particles that are disposed on the surface of the intermediate workpiece.

### TECHNICAL FIELD

The concepts described herein related to workpieces that are produced employing additive manufacturing techniques.

### BACKGROUND

Additive manufacturing is a process for manufacturing components that may be employed in numerous applications, including components that are fabricated from aluminum alloys. Components fabricated from aluminum alloys may experience corrosion, and surface coatings and finishes may be applied to form a barrier to reduce or prevent such corrosion.

Workpieces that are fabricated from aluminum alloys employing additive manufacturing may have high silicon content, which may result in finely dispersed silicon particles through the bulk of the workpiece including on the surface. The presence of finely dispersed silicon particles on a surface of a workpiece may interfere with addition of inorganic coatings to the surface, which may reduce adhesion of subsequently applied surface coatings in the form of paint or sealants. This may affect corrosion resistance and corrosion protection of a workpiece.

Known processes to reduce or eliminate finely dispersed silicon particles on a surface of a workpiece include etching the surface with a high fluoride concentration solution, which may be undesirable. It is desirable to prepare a surface of a workpiece fabricated from an aluminum alloy including silicon without employing a high fluoride-based etching material or etchant.

### SUMMARY

A process for preparing a surface of a workpiece for application of a corrosion-resistant finish material is described, wherein the workpiece is fabricated from an aluminum alloy that includes silicon. In one embodiment, the process includes processing a surface of an additively-manufactured (AM) workpiece in preparation for application of a corrosion-resistant finish material, wherein the AM workpiece is fabricated from an aluminum alloy that includes silicon. The process includes using a heat-treating process to heat the AM workpiece to achieve a desired temperature for finely dispersed silicon particles that are disposed on a surface thereof. This causes the finely dispersed silicon particles to aggregate into larger particles, decreasing their surface area and increasing a surface area of the aluminum. The aggregated silicon particles may be removed by surface cleaning or etching with a low-fluoride etchant prior to application of a conversion coating on the workpiece. A finish material may be applied after application of the conversion coating on the workpiece to provide corrosion resistance, to provide wear/abrasion resistance, to create a desired visual appearance, to provide electrical conductivity or electrical isolation, to provide fluidic sealing, to provide heat resistance, and to prepare the surface of the workpiece for adhesion or bonding.

As described herein, a method for processing a raw workpiece into a final workpiece is described, wherein the raw workpiece includes a metallic structure including silicon particles dispersed therein. The raw workpiece is fabricated employing an additive manufacturing process, in one embodiment. The method includes heat-treating the raw workpiece to produce an intermediate workpiece, wherein the heat-treating includes subjecting the raw workpiece to a first temperature environment for a time period to agglomerate a portion of the silicon particles to form agglomerated silicon particles, wherein the agglomerated silicon particles are disposed on a surface of the intermediate workpiece. The method further includes removing the agglomerated silicon particles that are disposed on the surface of the intermediate workpiece.

An aspect of the disclosure includes heat-treating of the raw workpiece by subjecting the raw workpiece to a first temperature environment of 400° C. to 550° C. for 1 to 10 hours.

Another aspect of the disclosure includes heat-treating of the raw workpiece by hardening the raw workpiece.

Another aspect of the disclosure includes heat-treating of the raw workpiece by subjecting the raw workpiece to an aging process.

Another aspect of the disclosure includes the subjecting the raw workpiece to the aging process by subjecting the raw workpiece to a temperature environment of 125° C. to 200° C. for a period of 4 to 16 hours.

Another aspect of the disclosure includes coating the surface of the intermediate workpiece to produce the final workpiece.

Another aspect of the disclosure includes coating of the surface of the intermediate workpiece by immersing the intermediate workpiece in a bath containing a coating material.

Another aspect of the disclosure includes coating of the surface of the intermediate workpiece by anodizing the intermediate workpiece.

Another aspect of the disclosure includes the removing of the agglomerated silicon particles that is disposed on the surface of the intermediate workpiece by etching the intermediate workpiece with a low-fluoride etchant.

Another aspect of the disclosure includes subjecting the raw workpiece to a stress-relief temperature environment prior to the heat-treating of the raw workpiece.

Another aspect of the disclosure includes the stress-relief temperature environment being a temperature environment of 250° C. to 400° C. for 0.5 hours to 0.8 hours

Another aspect of the disclosure includes processing a raw workpiece into a final workpiece, wherein the raw workpiece is fabricated from an aluminum alloy that includes silicon by: pre-cleaning the raw workpiece; heat-treating the raw workpiece, wherein the heat-treating includes subjecting the raw workpiece to a first temperature environment for a time period to produce an intermediate workpiece, wherein the first temperature environment effects agglomeration of silicon disposed on a surface of the intermediate workpiece; and removing the silicon disposed on the surface of the intermediate workpiece.

Another aspect of the disclosure includes heat-treating the raw workpiece by subjecting the raw workpiece to a temperature environment of 400° C. to 550° C. for 1 to 10 hours; hardening the raw workpiece; and subjecting the raw workpiece to an aging process.

Another aspect of the disclosure includes subjecting the raw workpiece to the aging process by subjecting the raw workpiece to a temperature environment of 125° C. to 200° C. for a period of 4 to 16 hours.

Another aspect of the disclosure includes fabricating, employing an additive manufacturing process, the raw workpiece from the aluminum alloy that includes silicon.

Another aspect of the disclosure includes fabricating, employing the additive manufacturing process, the raw workpiece from the aluminum alloy that includes silicon by fabricating the raw workpiece employing a laser powder bed process. Another aspect of the disclosure includes subjecting the raw workpiece to a stress-relief temperature environment prior to the heat-treating of the raw workpiece, wherein the stress-relief temperature environment includes a temperature environment of 250° C. to 400° C. for 0.5 hours to 0.8 hours.

Another aspect of the disclosure includes a final workpiece, wherein the final workpiece includes a raw workpiece formed from an aluminum alloy including silicon employing an additive manufacturing process, wherein the raw workpiece is subjected to a heat-treating process to produce an intermediate workpiece, wherein the heat-treating process includes subjecting the raw workpiece to a first temperature environment for a defined period of time sufficient to agglomerate a portion of the silicon to form agglomerated silicon particles, wherein the agglomerated silicon particles are disposed on a surface of the intermediate workpiece; and wherein the agglomerated silicon particles disposed on the surface of the intermediate workpiece are removed.

Another aspect of the disclosure includes a conversion coating being applied to the surface of the intermediate workpiece.

Another aspect of the disclosure includes the silicon disposed on the surface of the intermediate workpiece being removed by a low fluoride etching process.

Another aspect of the disclosure includes the raw workpiece being fabricated from an alloy that includes aluminum (Al) and silicon (Si), or an alloy that includes aluminum (Al), silicon (Si), and magnesium (Mg), or an alloy that includes aluminum (Al), silicon (Si), and copper (Cu), or a combination of an alloy that includes aluminum (Al) and silicon (Si), an alloy that includes an Al—Si alloy, an Al—Si—Mg alloy, and an Al—Si—Cu alloy.

Another aspect of the disclosure includes an intermediate workpiece including an aluminum alloy including silicon formed into a raw workpiece having a predefined shape employing an additive manufacturing process, wherein the aluminum alloy includes a metal matrix and the silicon includes agglomerated silicon particles dispersed within the metal matrix.

Another aspect of the disclosure includes the agglomerated silicon particles dispersed within the metal matrix being formed by subjecting the raw workpiece to a heat-treating process to produce an intermediate workpiece, wherein a portion of the agglomerated silicon particles are disposed on a surface of the intermediate workpiece, and wherein the agglomerated silicon particles that are disposed on the surface of the intermediate workpiece are removed.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

One or more embodiments will now be described, by way of example, with reference to the accompanying drawings, in which:

FIG. 1 schematically illustrates a perspective view of a workpiece that was formed from an aluminum-silicon alloy employing an additive manufacturing process, in accordance with the disclosure.

FIG. 2 schematically illustrates a process for processing a raw workpiece that was formed from an aluminum-silicon alloy into a final workpiece, in accordance with the disclosure.

FIG. 3 pictorially shows an elemental map of portion of a cutaway side view of a raw workpiece that was formed from an aluminum-silicon alloy employing an additive manufacturing process, in accordance with the disclosure.

FIG. 4 pictorially shows an elemental map of portion of a cutaway side view of an intermediate workpiece that was formed from an aluminum-silicon alloy employing an additive manufacturing process after being subjected to a heat-treating process, in accordance with the disclosure.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features.

A method for processing a raw workpiece into a final workpiece is described, wherein the raw workpiece includes a metallic structure including silicon particles dispersed therein. In one embodiment, the raw workpiece is fabricated employing an additive manufacturing process. The method includes heat-treating the raw workpiece to form an intermediate workpiece, wherein the heat-treating includes subjecting the raw workpiece to a first temperature environment for a time period to agglomerate a portion of the silicon particles to form agglomerated silicon particles, wherein the agglomerated silicon particles are disposed on a surface of the raw workpiece. The method further includes removing the agglomerated silicon particles that are disposed on the surface of the intermediate workpiece. Alternatively, the method also includes processing the raw workpiece into a final workpiece, wherein the raw workpiece is fabricated from an aluminum alloy that includes silicon. The method includes pre-cleaning the raw workpiece, and heat-treating the raw workpiece, wherein the heat-treating includes subjecting the raw workpiece to a first temperature environment for a time period, wherein the first temperature environment effects agglomeration of silicon disposed on a surface of the raw workpiece, and removing the silicon disposed on the surface of the raw workpiece.

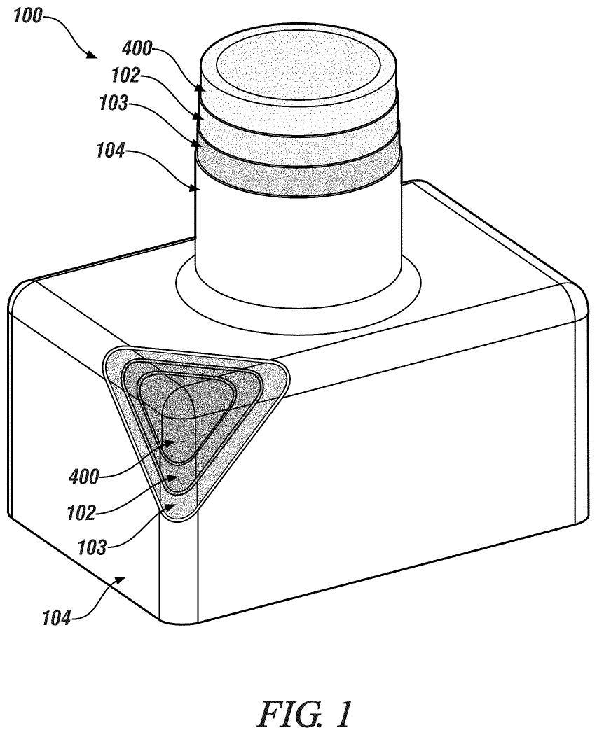

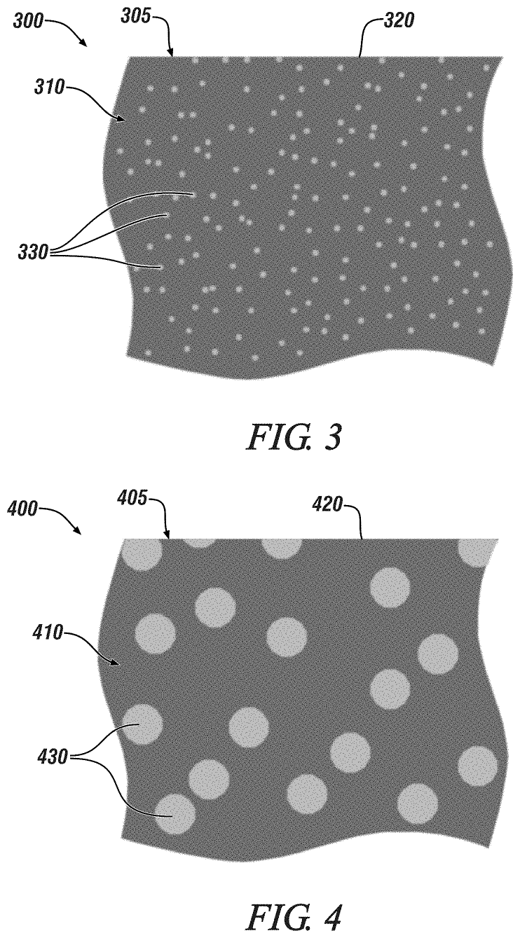

As used herein, the term “workpiece” refers to a tangible object having a predefined shape on which one or more processing steps are performed. The workpiece includes a raw workpiece 300, a portion of which is shown with reference to FIG. 3. The workpiece includes an intermediate workpiece 400, a portion of which is shown with reference to FIG. 4. The intermediate workpiece 400 refers to the raw workpiece 300 after having been subjected to heat-treating. The workpiece includes the final workpiece 100, which refers to the intermediate workpiece 400 after coating. An embodiment of the final workpiece 100 is shown with reference to FIG. 1.

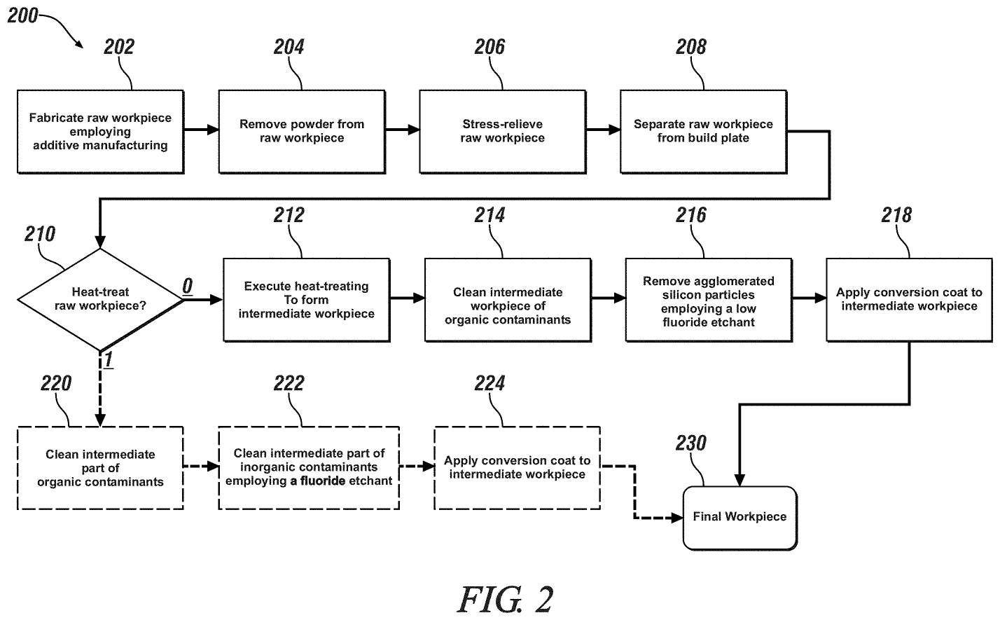

Referring again to the drawings, wherein like reference numerals correspond to like or similar components throughout the several Figures, FIG. 1, consistent with embodiments disclosed herein, illustrates an embodiment of the final workpiece 100 that includes the intermediate workpiece 400 that has been subject to a conversion coating 102, a primer coating 103, and a paint coating 104. The intermediate workpiece 400 includes an embodiment of the raw workpiece 300 shown with reference to FIG. 3 that has been fabricated from an aluminum alloy that includes silicon and has been subjected to heat-treating in a manner that is described with reference to FIG. 2.

In one embodiment, the raw workpiece 300 shown with reference to FIG. 3 is fabricated to a predefined shape employing an additive manufacturing process, which may include a laser powder bed fusion process to form the raw workpiece 300 from an alloy that includes aluminum (Al) and silicon (Si), wherein the Al—Si alloy is in powder form. Alternatively, another additive manufacturing process may be employed to form the raw workpiece 300 from an Al—Si alloy.

The raw workpiece 300 is fabricated from an alloy that includes aluminum (Al) and silicon (Si). In one embodiment, the raw workpiece 300 is fabricated from an alloy that includes aluminum (Al), silicon (Si), and magnesium (Mg). In one embodiment, the raw workpiece 300 is fabricated from AlSi10Mg. In one embodiment, the raw workpiece 300 is fabricated from an alloy that includes aluminum (Al), silicon (Si), and copper (Cu). In one embodiment, the raw workpiece 300 is fabricated from a combination of an alloy that includes aluminum (Al) and silicon (Si), an alloy that includes aluminum (Al), silicon (Si), and magnesium (Mg), and an alloy that includes aluminum (Al), silicon (Si), and copper (Cu).

As shown, the final workpiece 100 includes the intermediate workpiece 400 that has been coated with a conversion coating 102, a primer coating 103, and a paint coating 104.

Alternatively, the final workpiece 100 includes the intermediate workpiece 400 that has been coated with the conversion coating 102.

Alternatively, the final workpiece 100 includes the intermediate workpiece 400 that has been coated with the conversion coating 102 and the paint coating 104.

Alternatively, the final workpiece 100 includes the intermediate workpiece 400 that has been coated with the primer coating 103 and the paint coating 104.

Alternatively, the final workpiece 100 includes the intermediate workpiece 400 that has been coated with the primer coating 103.

Alternatively, the final workpiece 100 includes the intermediate workpiece 400 that has been coated with the paint coating 104.

FIG. 2 schematically shows an embodiment of a method 200, in the form of a flowchart, for processing an embodiment of the raw workpiece 300 that is shown with reference to FIG. 3 into an embodiment of the final workpiece 100 that is shown with reference to FIG. 1. As employed herein, the term “1” indicates an answer in the affirmative, or “YES”, and the term “0” indicates an answer in the negative, or “NO”. Further, dashed boxes indicate that the step is optional and may be included in at least some embodiments alone or in combination with other optional steps.

The method 200 includes heat treating (Step 212) a raw workpiece 300 and removing (Step 216) agglomerated silicon particles 430 from the raw workpiece 300 or an intermediate workpiece 400. In one example, heat treating (Step 212) the raw workpiece 300 produces an intermediate workpiece 400 and the agglomerated silicon particles 430 are removed from the intermediate workpiece 400.

The method 200 includes a method for processing a raw workpiece 300 into a final workpiece 100, wherein the raw workpiece 300 includes a metallic structure 310 including silicon particles 330 dispersed therein, the method 200 includes heat-treating the raw workpiece 300 to produce an intermediate workpiece 400 (210), wherein the heat-treating includes subjecting the raw workpiece 300 to a first temperature environment for a time period to agglomerate a portion of the silicon particles to produce agglomerated silicon particles 430, wherein the agglomerated silicon particles 430 are disposed on a surface 405 of the intermediate workpiece 400; and removing the agglomerated silicon particles 430 that are disposed on the surface 405 of the intermediate workpiece 400 (216).

The method 200 includes a method for processing a raw workpiece 300 into a final workpiece 100, wherein the raw workpiece 300 is fabricated from an aluminum alloy 310 that includes silicon 330. The method includes subjecting the raw workpiece 300 to a stress-relief temperature environment; heat-treating the raw workpiece 300 to produce an intermediate workpiece 400, wherein the heat-treating includes subjecting the raw workpiece 300 to a first temperature environment for a time period, wherein the first temperature environment produces the intermediate workpiece 400 including agglomerated silicon particles 405 disposed on a surface thereof; and removing the agglomerated silicon particles 405 disposed on the surface of the intermediate workpiece 400.

The method 200 includes a step to fabricate the raw workpiece 300 employing an additive manufacturing process (202) wherein the raw workpiece 300 has been fabricated from an alloy that includes aluminum (Al) and silicon (Si). In one embodiment, the additive manufacturing process includes a laser powder bed fusion process to form the raw workpiece 300 from an alloy that includes aluminum (Al) and silicon (Si), wherein the Al—Si alloy is in powder form. Alternatively, another additive manufacturing process may be employed to form the raw workpiece 300 from an Al—Si alloy. In one embodiment, the Al—Si alloy includes aluminum (Al), silicon (Si), and magnesium (Mg). In one embodiment, the Al—Si alloy is AlSi10Mg. In one embodiment, the Al—Si alloy includes aluminum (Al), silicon (Si), and copper (Cu). In one embodiment, the Al—Si alloy includes an Al—Si alloy, an Al—Si—Mg alloy, and an Al—Si—Cu alloy.

The raw workpiece 300 is subjected to an initial cleaning step (204) to remove powder and other surface contaminants from the raw workpiece 300 employing a solvent such as methyl propyl ketone (MPK), methyl ethyl ketone (MEK), or acetone. Alternatively, the initial cleaning step (204) includes employing a degreasing solution in the form of a surfactant-based cleaning solution that is applied to a surface of the raw workpiece 300 in vapor form or aqueous form to remove powder and other surface contaminants such as grease, oils, etc. from the raw workpiece.

After the initial cleaning step, the raw workpiece 300 is subjected to a stress-relief process (206). The stress-relief process includes subjecting the raw workpiece 300 to a stress-relief temperature environment for a defined time period. The stress-relief temperature environment includes a temperature environment of 250° C. to 400° C. for 0.5 hours to 0.8 hours when the raw workpiece is formed from one of the Al—Si alloys described herein.

After the stress-relief process in completed, the raw workpiece 300 may be separated from a build plate that is formed during the additive manufacturing process (208) by sawing, cutting, laser cutting, etc.

FIG. 3 shows an example of the raw workpiece 300 that can be used the method 200 shown in FIG. 2. The raw workpiece 300 is formed from an aluminum alloy 310 that includes silicon. More specifically, the aluminum alloy 310 includes a metal matrix 320 and relatively small silicon particles 330 that are finely dispersed throughout the metal matrix 320. The aluminum alloy 310 defines a surface 305 of the raw workpiece 300. The small silicon particles 330 can also be on the surface 305 of the raw workpiece 300.

The raw workpiece 300 includes a metallic structure including silicon particles dispersed therein that has a predefined shape that has been formed employing an additive manufacturing process using an aluminum alloy 310 that includes silicon. More specifically, the aluminum alloy 310 includes a metal matrix 320 and relatively small silicon particles 330 that are finely dispersed throughout the metal matrix 320. The aluminum alloy 310 defines a surface 305 of the raw workpiece 300. The small silicon particles 330 can also be finely dispersed on the surface 305 of the raw workpiece 300. The small particles of the silicon 330 that are finely dispersed across the surface 305 of the raw workpiece 300 may interfere with coating because the small particles of the silicon 330 interfere with adherence of coating materials to the surface 305, thus affecting the corrosion resistance, surface appearance, and surface finish of the coating.

Referring again to FIG. 2, a decision is made (210) whether to subject the raw workpiece 300 to a heat-treating process (212). When the heat-treating process is selected (210)(1), the raw workpiece 300 is subjected to heat-treating, thus forming the intermediate workpiece 400, a portion of which is illustrated with reference to FIG. 4 (212). The heat-treating step (212) includes exposing the raw workpiece 300 to a first temperature environment for a time period. The heat-treating step (212) may further include hardening the raw workpiece 300 after exposure to the first temperature environment in one embodiment. The heat-treating step (212) may further include subjecting the raw workpiece 300 to an aging process.

The purpose of the heat-treating step (212) is to effect agglomeration of silicon disposed on the surface of the raw workpiece 300, i.e., to cause the small particles of silicon that are dispersed across the surface of the raw workpiece 300 to become mobile and agglomerate into larger groups, which decreases the surface area of silicon relative to aluminum. The agglomeration may be due, at least in part, to a phenomenon referred to as Oswalt ripening, wherein small silicon crystals dissolve and redeposit onto larger silicon crystals over time. The heat-treating step (212) accelerates the Oswalt ripening phenomenon. When the silicon agglomerates into relatively larger groups on the surface of the raw workpiece 300, the increase in the portion of the surface area that is aluminum increases adherence of coating materials such as epoxies or urethanes. Furthermore, when the silicon agglomerates into relatively larger groups on the surface of the raw workpiece 300, the silicon is more amenable to being removed in subsequent processing steps that may occur prior to conversion coating and other subsequent steps.

Subjecting the raw workpiece 300 to the heat-treating step (212) includes exposing the raw workpiece 300 to a first temperature environment for a time period, wherein the first temperature environment is determined based upon physical properties of silicon related to its solid phase and its liquid phase. Specifically, the first temperature environment is selected to increase a solid-diffusion rate to cause silicon that is disposed on the surface of the raw workpiece 300 to agglomerate, while avoiding a liquification temperature associated with the aluminum. In one embodiment, this includes subjecting the raw workpiece to a first temperature environment of 400° C. to 550° C. for 1 to 10 hours.

FIG. 4 an embodiment of the intermediate workpiece 400, using the method 200 that is shown with reference to FIG. 2, including by heat-treating an embodiment of the raw workpiece 300 that is shown with reference to FIG. 3. The intermediate workpiece 400 includes an aluminum alloy 410 including silicon formed into a raw workpiece 300 having a predefined shape employing an additive manufacturing process, wherein the aluminum alloy 410 includes a metal matrix 420 and the silicon includes agglomerated silicon particles 430 dispersed within the metal matrix 420. FIG. 4 depicts the aluminum alloy 410, which includes the metal matrix 420 and agglomerated silicon particles 430 that are dispersed throughout the metal matrix 420 including on the surface 405 thereof. The agglomerated silicon particles 430 are formed by subjecting the raw workpiece 300 to the heat-treating step (212) that is described with reference to FIG. 2. A portion of the agglomerated silicon particles 430 are disposed on the surface 405 of the intermediate workpiece 400.

When the agglomerated silicon particles 430 are removed from the surface 405 of the intermediate workpiece 400, any additional steps shown in FIG. 2 can be performed to produce the final workpiece from the intermediate workpiece 400. An example of a final workpiece 100 formed using the method of 200 to transform the raw workpiece 300 (shown in FIG. 3) into the intermediate workpiece 400 (shown in FIG. 4) is shown in FIG. 1.

The surface 405 may be exposed to an etching process to remove the agglomerated silicon particles 430 to improve adherence of coating materials thereto, as described with reference to FIG. 2. The aluminum alloy 410 of FIG. 4 is the same as the aluminum alloy 310 of FIG. 3, but the metal matrix 420 and the agglomerated silicon particles 430 differ from the metal matrix 320 and relatively small silicon particles 330 shown with reference to FIG. 3. When the agglomerated silicon particles 430 are removed from the surface 405 of the intermediate workpiece 400, any additional steps shown in FIG. 2 can be performed to produce the final workpiece from the intermediate workpiece 400. An example of a final workpiece 100 formed using the method 200 of FIG. 2 to transform the raw workpiece 300 (shown in FIG. 3) into the intermediate workpiece 400 (shown in FIG. 4) is shown in FIG. 1.

Referring again to FIG. 2, the heat-treating step (212) may further include hardening the raw workpiece after exposure to the first temperature environment in one embodiment. In one embodiment, hardening the raw workpiece includes quenching the raw workpiece by immersing the raw workpiece into a liquid bath, such as a water bath, that is maintained at a temperature range between 15° C. and 32° C. In one embodiment, the heat-treating step (212) does not include hardening; instead the raw workpiece is cooled by exposure to room temperature.

The heat-treating step (212) may further include subjecting the raw workpiece to an aging process. In one embodiment, subjecting the raw workpiece to the aging process may include subjecting the raw workpiece 300 to a temperature environment of 125° C. to 200° C. for a period of 4 to 16 hours after exposure to the first temperature environment and/or after hardening.

The intermediate workpiece 400 may be subjected to a series of processes to clean the intermediate workpiece 400 of organic contaminants (214).

The intermediate workpiece 400 is cleaned of inorganic contaminants employing a low-fluoride etchant (216), which may include etching the intermediate workpiece 400 with a low-fluoride etchant. The low-fluoride etchant serves to remove agglomerated silicon particles that are disposed on the surface of the intermediate workpiece 400. In one embodiment, a low-fluoride etchant is an etchant containing 0.05 to 0.5 wt. % of fluoride. This may involve processing the intermediate workpiece 400 through a series of immersion tanks containing inorganic coatings such as a solvent clean or degrease.

Organic coatings such as primer, paint, or sealants are applied following application of the inorganic coatings. This may include processing the intermediate workpiece through a series of immersion tanks containing an alkaline cleaner or an alkaline etch to deoxidize or desmut the surface of the intermediate workpiece. A conversion coat is applied to the surface of the intermediate workpiece in preparation for corrosion protection and/or painting (218). Conversion coatings are used on aluminum to chemically change the surface to provide corrosion protection, improve adhesion of subsequent organic finishes, increase or reduce electrical conductivity, increase surface hardness, and provide a pretreatment for subsequent finishing or bonding. Conversion coating can be in the form of an anodized coating or a chromate conversion coating. The resultant is the final workpiece 100 (230), which may be further processed by applying a primer coat, paint, and/or a sealant.

A primer coat may include an epoxy-based coating material, or a urethane-based coating material. The primer coat provides for primary corrosion protection, and may be chromated. The primer coat provides improved surface adhesion for application of paints and/or sealants. A paint coat may include a urethane-based material that is applied for wear resistance, appearance, decorative livery and other purposes. A sealant coat may be a polysulfide-based material or a silicone-based material, and may be chromated for corrosion protection. The sealant prevents moisture ingression leading to corrosion and mitigates effects of depressurization.

When the heat-treating process is not selected (210)(0), the raw workpiece 300 may be subjected to a series of cleaning processes to remove organic contaminants (220) and clean the intermediate workpiece of inorganic contaminants (222), which may include etching the raw workpiece 300 with a high fluoride etchant. This may involve processing the raw workpiece 300 through one or a series of immersion tanks. Organic coatings such as primer, paint, or sealants may be applied following the etchant, and a conversion coating may be applied to the surface of the intermediate workpiece in preparation for corrosion protection and/or painting (224). Conversion coatings are used on aluminum to chemically change the surface to provide corrosion protection, to improve adhesion of subsequent organic finishes, to increase or reduce electrical conductivity, to increase surface hardness, and to provide a pretreatment for subsequent finishing or bonding. The resultant is the final workpiece (230), which may be further processed.

The following Clauses provide example configurations of a method for processing a raw workpiece into a final workpiece, as disclosed herein.

Clause 1: A method for processing a raw workpiece into a final workpiece, wherein the raw workpiece includes a metallic structure including silicon particles dispersed therein, the method comprising: heat-treating the raw workpiece to produce an intermediate workpiece, wherein the heat-treating includes subjecting the raw workpiece to a first temperature environment for a time period to agglomerate a portion of the silicon particles to form agglomerated silicon particles, wherein the agglomerated silicon particles are disposed on a surface of the raw workpiece; and removing the agglomerated silicon particles that are disposed on the surface of the intermediate workpiece.

Clause 2. The method of Clause 1, wherein the heat-treating of the raw workpiece comprises subjecting the raw workpiece to a first temperature environment of 400° C. to 550° C. for 1 to 10 hours.

Clause 3. The method of any of Clauses 1 to 2, wherein the heat-treating of the raw workpiece further comprises hardening the raw workpiece.

Clause 4. The method of any of Clauses 1 to 3, wherein the heat-treating of the raw workpiece further comprises subjecting the raw workpiece to an aging process.

Clause 5. The method of any of Clauses 1 to 4, wherein the subjecting the raw workpiece to the aging process comprises subjecting the raw workpiece to a temperature environment of 125° C. to 200° C. for a period of 4 to 16 hours.

Clause 6. The method of any of Clauses 1 to 5, further comprising removing of the agglomerated silicon particles that are disposed on the surface of the intermediate workpiece by etching the intermediate workpiece with a low-fluoride etchant.

Clause 7. The method of any of Clauses 1 to 6, further comprising coating the surface of the intermediate workpiece to produce the final workpiece.

Clause 8. The method of any of Clauses 1 to 7, wherein the coating of the surface of the intermediate workpiece comprises immersing the intermediate workpiece in a bath containing a coating material.

Clause 9. The method of any of Clauses 1 to 8, wherein the coating of the surface of the intermediate workpiece comprises anodizing the intermediate workpiece.

Clause 10. The method of any of Clauses 1 to 9, further comprising subjecting the raw workpiece to a stress-relief temperature environment prior to the heat-treating of the raw workpiece.

Clause 11. The method of any of Clauses 1 to 11, wherein the stress-relief temperature environment comprises a temperature environment of 250° C. to 400° C. for 0.5 hours to 0.8 hours.

Clause 12. A method for processing a raw workpiece into a final workpiece, wherein the raw workpiece is fabricated from an aluminum alloy that includes silicon, the method comprising: pre-cleaning the raw workpiece; heat-treating the raw workpiece, wherein the heat-treating includes subjecting the raw workpiece to a first temperature environment for a time period, wherein the first temperature environment effects agglomeration of silicon disposed on a surface of the raw workpiece; and removing the silicon disposed on the surface of the raw workpiece.

Clause 13. The method of any of Clauses 11 to 12, wherein the heat-treating the raw workpiece by subjecting the raw workpiece to the first temperature environment for the time period comprises: subjecting the raw workpiece to a temperature environment of 400° C. to 550° C. for 1 to 10 hours; hardening the raw workpiece; and subjecting the raw workpiece to an aging process.

Clause 14. The method of any of Clauses 11 to 13, wherein the subjecting the raw workpiece to the aging process comprises subjecting the raw workpiece to a temperature environment of 125° C. to 200° C. for a period of 4 to 16 hours.

Clause 15. The method of any of Clauses 11 to 14, further comprising fabricating, employing an additive manufacturing process, the raw workpiece from the aluminum alloy that includes silicon.

Clause 16. The method of any of Clauses 11 to 15, wherein the fabricating, employing the additive manufacturing process, the raw workpiece from the aluminum alloy that includes silicon comprises fabricating the raw workpiece employing a laser powder bed process.

Clause 17. The method of any of Clauses 11 to 16, further comprising subjecting the raw workpiece to a stress-relief temperature environment prior to the heat-treating of the raw workpiece, wherein the stress-relief temperature environment comprises a temperature environment of 250° C. to 400° C. for 0.5 hours to 0.8 hours.

Clause 18. An intermediate workpiece comprising an aluminum alloy including silicon formed into a raw workpiece having a predefined shape employing an additive manufacturing process, wherein the aluminum alloy comprises a metal matrix and the silicon comprises agglomerated silicon particles dispersed within the metal matrix.

Clause 19. The intermediate workpiece of claim 18, wherein the agglomerated silicon particles dispersed within the metal matrix are formed by subjecting the raw workpiece to a heat-treating process; wherein a portion of the agglomerated silicon particles are disposed on a surface of the raw workpiece; and wherein the agglomerated silicon particles that are disposed on the surface of the raw workpiece are removed.

Clause 20. The intermediate workpiece of claims 18 to 19, wherein the raw workpiece formed from the aluminum alloy including silicon comprises the raw workpiece being formed from an alloy that includes aluminum (Al) and silicon (Si), or an alloy that includes aluminum (Al), silicon (Si), and magnesium (Mg), or an alloy that includes aluminum (Al), silicon (Si), and copper (Cu), or a combination of an alloy that includes aluminum (Al) and silicon (Si), an alloy that includes an Al—Si alloy, an Al—Si—Mg alloy, and an Al—Si—Cu alloy.

The components of the disclosed embodiments, as described and illustrated herein, may be arranged and designed in a variety of different configurations. Thus, the detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

Furthermore, the detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A method for processing a raw workpiece into a final workpiece, wherein the raw workpiece includes a metallic structure including silicon particles dispersed therein, the method comprising:
heat-treating the raw workpiece to produce an intermediate workpiece, wherein the heat-treating includes subjecting the raw workpiece to a first temperature environment for a time period to agglomerate a portion of the silicon particles to produce agglomerated silicon particles, wherein the agglomerated silicon particles are disposed on a surface of the intermediate workpiece; and
removing the agglomerated silicon particles that are disposed on the surface of the intermediate workpiece.

2. The method of claim 1, wherein the heat-treating of the raw workpiece comprises subjecting the raw workpiece to a first temperature environment of 400° C. to 550° C. for 1 to 10 hours.

3. The method of claim 2, wherein the heat-treating of the raw workpiece further comprises hardening the raw workpiece.

4. The method of claim 3, wherein the heat-treating of the raw workpiece further comprises subjecting the raw workpiece to an aging process.

5. The method of claim 4, wherein the subjecting the raw workpiece to the aging process comprises subjecting the raw workpiece to a temperature environment of 125° C. to 200° C. for a period of 4 to 16 hours.

6. The method of claim 1, wherein the removing of the agglomerated silicon particles that are disposed on the surface of the intermediate workpiece comprises etching the intermediate workpiece with a low-fluoride etchant.

7. The method of claim 1, further comprising coating the surface of the intermediate workpiece to produce the final workpiece.

8. The method of claim 7, wherein the coating of the surface of the intermediate workpiece comprises immersing the intermediate workpiece in a bath containing a coating material.

9. The method of claim 7, wherein the coating of the surface of the intermediate workpiece comprises anodizing the intermediate workpiece.

10. The method of claim 1, further comprising subjecting the raw workpiece to a stress-relief temperature environment prior to the heat-treating of the raw workpiece.

11. The method of claim 10, wherein subjecting the raw workpiece to a stress-relief temperature environment prior to the heat-treating of the raw workpiece comprises subjecting the raw workpiece to a temperature environment within a range of 250° C. to 400° C. for 0.5 hours to 0.8 hours.

12. A method for processing a raw workpiece into a final workpiece, wherein the raw workpiece is fabricated from an aluminum alloy that includes silicon, the method comprising:
subjecting the raw workpiece to a stress-relief temperature environment;
heat-treating the raw workpiece to produce an intermediate workpiece, wherein the heat-treating includes subjecting the raw workpiece to a first temperature environment for a time period, wherein the first temperature environment produces the intermediate workpiece including agglomerated silicon particles disposed on a surface thereof; and
removing the agglomerated silicon particles disposed on the surface of the intermediate workpiece.

13. The method of claim 12, wherein the heat-treating the raw workpiece to produce the intermediate workpiece by subjecting the raw workpiece to the first temperature environment for the time period comprises:
subjecting the raw workpiece to a temperature environment of 400° C. to 550° C. for 1 to 10 hours;
hardening the raw workpiece; and
subjecting the raw workpiece to an aging process.

14. The method of claim 13, wherein the subjecting the raw workpiece to the aging process comprises subjecting the raw workpiece to a temperature environment of 125° C. to 200° C. for a period of 4 to 16 hours.

15. The method of claim 12, further comprising fabricating, employing an additive manufacturing process, the raw workpiece from the aluminum alloy that includes silicon.

16. The method of claim 15, wherein the fabricating, employing the additive manufacturing process, the raw workpiece from the aluminum alloy that includes silicon comprises fabricating the raw workpiece employing a laser powder bed process.

17. The method of claim 12, wherein subjecting the raw workpiece to the stress-relief temperature environment comprises subjecting the raw workpiece to a temperature environment of 250° C. to 400° C. for 0.5 hours to 0.8 hours.

18. An intermediate workpiece comprising:
an aluminum alloy including silicon formed into a raw workpiece having a predefined shape employing an additive manufacturing process, wherein the aluminum alloy comprises a metal matrix and the silicon comprises agglomerated silicon particles dispersed within the metal matrix.

19. The intermediate workpiece of claim 18, wherein the agglomerated silicon particles dispersed within the metal matrix are formed by subjecting the raw workpiece to a heat-treating process to produce the intermediate workpiece;
wherein a portion of the agglomerated silicon particles are disposed on a surface of the intermediate workpiece; and
wherein the agglomerated silicon particles that are disposed on the surface of the intermediate workpiece are removed.

20. The intermediate workpiece of claim 18, wherein the raw workpiece formed from the aluminum alloy including silicon comprises the raw workpiece being formed from an alloy that includes aluminum (Al) and silicon (Si), or an alloy that includes aluminum (Al), silicon (Si), and magnesium (Mg), or an alloy that includes aluminum (Al), silicon (Si), and copper (Cu), or a combination of an alloy that includes aluminum (Al) and silicon (Si), an alloy that includes an Al—Si alloy, an Al—Si—Mg alloy, and an Al—Si—Cu alloy.
